(19) United States
(12) Patent Application Publication
(10) Pub. No.: US 2011/0293796 A1
(43) Pub. Date: Dec. 1, 2011

(54) SODA-POP FLAVORED COCOA BUTTER BASED CONFECTION

(76) Inventors: Brian Crowley, Jersey City, NJ (US); Christopher Najmeddine, Jersey City, NJ (US)

(21) Appl. No.: 13/207,395

(22) Filed: Aug. 10, 2011

Related U.S. Application Data
(63) Continuation-in-part of application No. 12/930,796, filed on Jan. 18, 2011.
(60) Provisional application No. 61/295,860, filed on Jan. 18, 2010.

(51) Int. Cl. A23G 3/46; A23G 3/54

(52) U.S. Cl. 426/103; 426/580; 426/586; 426/581; 426/587; 426/588; 426/583; 426/585

(57) ABSTRACT

A soda-pop flavored confection made of powdered anhydrous soda-pop flavoring components, along with sweeteners dairy and suitable confectionary fat wherein the intimate incorporation of the soda-pop flavoring results in a confection that has a primary flavor profile of the soda-pop but a mouth feel of a chocolate or chocolate-like confection.

This application is a continuation-in-part of U.S. patent application Ser. No. 12/930,796 entitled “Fruit Chocolate” filed Jan. 18, 2011, which claims priority to U.S. provisional application No. 61/295,860 filed Jan. 18, 2010.

### FIELD OF INVENTION

The present invention relates generally to soda-pop confections having a suitable confectionary fat, oil or stearin as its principal fat constituent, a sweetener, a dairy component, and an anhydrous soda-pop flavoring intimately included therein. The confection of the present invention may optionally include inclusions such as gasified candy and/or encapsulated liquids.

### BACKGROUND OF THE INVENTION

Americans love chocolate. Sales of the confection in 2009 were $17.3 billion (Packaged Facts, Market in the U.S. 2010), and it is estimated that the average American consumes about 12 pounds of chocolate per year. In fact, when the Chocolate Manufacturers Association lobbied the federal government to permit confections containing hydrogenated vegetable oil in place of cocoa butter to be sold as “chocolate,” the public outcry forced the FDA to re-iterate that “Cacao fat, as one of the signature characteristics of the product, will remain a principal component of standardized chocolate” “FDA's Standards for High Quality Foods”. Food and Drug Administration.

http://www.fda.gov/consumer/updates/foodstandards061807.html.

Americans' love of chocolate is two-fold. First, the flavor of chocolate is preferred by the 66% of the populace with vanilla and fruit flavors a distant second and third. Second, the mouth feel, the chemical and physical relationship of food with the individual's mouth, is unique. The buttery smooth mouth feel of chocolate leaves the consumer feeling fulfilled, happy and/or relaxed. The importance of mouth feel to the consumer is highlighted by the above-noted response to the Chocolate Manufacturers Association's efforts to replace cocoa butter.

As noted above, chocolate is a popular flavor but not the sole flavor enjoyed by American's and therefore a need persists for confections having primary flavors—the first, predominant, and/or most persistent flavor impression—other than chocolate which provide the satisfying mouth feel of chocolate. In particular, a need has arisen for soda-pop flavored confections possessing the mouth feel of chocolate or chocolate-like confections.

Over the past few decades, American's consumption of carbonated beverages, soft drinks, cola, pop, soda-pop, tonics, etc., has skyrocketed. With this increased consumption of soft drinks, there has been a greater demand for soft drink flavored candies and confections. A number of soda-pop flavored candies are available on the market ranging from pressed sugar tablets such as PEZ™ (PEZ Candy, Inc., Orange, Conn.), gaseous powdered candies such as POP ROCKS (POP ROCKS® Inc., Atlanta, Ga.), jelly beans such as Dr. Pepper flavored JELLY BELLY™ jelly beans (Jelly Belly Candy Company, Fairfield, Calif.), taffy, bubble gum, to hard candies such as A&W™ root beer barrels (Farley & Sathers Candy Company, Inc., Round Lake, Minn.). However, none of these confections possess the buttery smoothness that provides the consumer with a feeling of happiness, fulfillment, and relaxation that chocolate or chocolate-like confections do. In fact, it has been noted that the sucking and chewing of hard candies actually leads to an agitated state.

Flavor oils imparting impressions of soda-pop flavors in chocolate products are known in prior art. However these flavor compounds in oil carriers offer but a ‘hint’ of the flavor when incorporated as directed by their manufacturer. Increasing the percentage of the flavored oils to try to achieve a stronger flavor tends to lead to an increased impression of artificial representation of the sought flavor. Thus to date, the use of these oils in confections has failed to produce a confection in which the soda-pop flavor is intimately incorporated into the chocolate or chocolate-like confection and wherein the soda-pop is the predominant flavoring of the confection.

Thus, there remains a need for a soda-pop flavored confection in which the soda-pop is the predominant flavoring that possesses the mouth feel of chocolate or chocolate-like confections.

The foregoing discussion is presented solely to provide a better understanding of the nature of the problems confronting the art and should not be construed in any way as an admission as to prior art nor should the citation of any reference herein be construed as an admission that such reference constitutes “prior art” to the instant application.

### SUMMARY OF THE INVENTION

The present invention is directed to a soda-pop confection made of a sweetener; a dairy product; an anhydrous soda-pop flavoring; and a suitable confectionary fat.

In a further embodiment of the invention, the anhydrous soda-pop flavoring is a concentrate of only the flavoring/coloring components of the soda-pop. The anhydrous soda-pop flavoring may also incorporate an anti-caking agent. The anti-caking agent may be maltodextrin. Also, the particle size of the anhydrous soda-pop flavoring may have a D⁹⁰ less than or equal to 15 μm. The anhydrous soda-pop flavoring may also comprise less than about 35% by weight of the confection.

Additionally, another embodiment of the invention is directed to a soda-pop confection in which the dairy product is cream, milkfat, butter, milk, concentrated milk, evaporated milk, sweetened condensed milk, dried milk, skim milk, concentrated skim milk, evaporated skim milk, sweetened condensed skim milk, nonfat dry milk, sweet cream buttermilk, concentrated buttermilk, dried buttermilk, malted milk, cultured milk (yogurt, kefir, etc.), dried cultured milk, whey, whey products, or combinations thereof.

The suitable confectionary fat of the soda-pop confection of the current invention may be a vegetable derived fat, oil, stearin, or combination thereof in yet another embodiment of this invention. The vegetable derived fat may be cocoa butter, shea butter; mowra butter; kokum butter; illipe butter; borneo tallow, or combinations thereof. The vegetable derived oil may be partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, or combinations thereof. In a preferred embodiment, the vegetable derived fat is cocoa butter.

In yet another embodiment of the invention, the sweetener in the confection is a nutritive sweetener.

In additional embodiments, the soda-pop confection of the current invention may include further components such as emulsifying agents, essential nutrients, minerals, biogenic amines, herbal extracts, stimulants, raw cocoa powder, dutched cocoa powder, and/or chocolate liquor. In those embodiments in which emulsifying agents are present, the total amount of the emulsifying agent preferably does not exceed about 2 percent by weight of the soda-pop confection. Further, the addition of essential nutrients, minerals, biogenic amines, herbal extracts, and/or stimulants may provide an additional embodiment of the invention in which the confection provides an energy enhancement to an individual consuming the confection.

In yet another embodiment of the current invention, the soda-pop confection may incorporate one or more inclusions. The inclusion may be gasified candy, encapsulated liquid(s), cookies, wafers, nougat, caramel, carob, pralines, crisped or puffed grains, taffy, toffee, pretzels, nuts, seeds, dried fruit, and/or combinations thereof. In a further embodiment wherein the inclusion is an encapsulated liquid, the encapsulated liquid may be a flavor enhanced lipophilic core inside a gelatin or alginate shell.

In a further embodiment of the invention, the soda-pop confection may be coated with a candy shell, confectioners glaze, confectioners wax, or combination thereof. Also, the soda-pop confection may be molded into the shape of a container or vessel having a closed reservoir therein. In a further variation of this embodiment the closed reservoir may contain a syrup with an alcohol content of less than about 10%.

### DESCRIPTION OF THE DRAWINGS

FIG. 1 depicts a process for manufacturing a soda-pop chocolate.

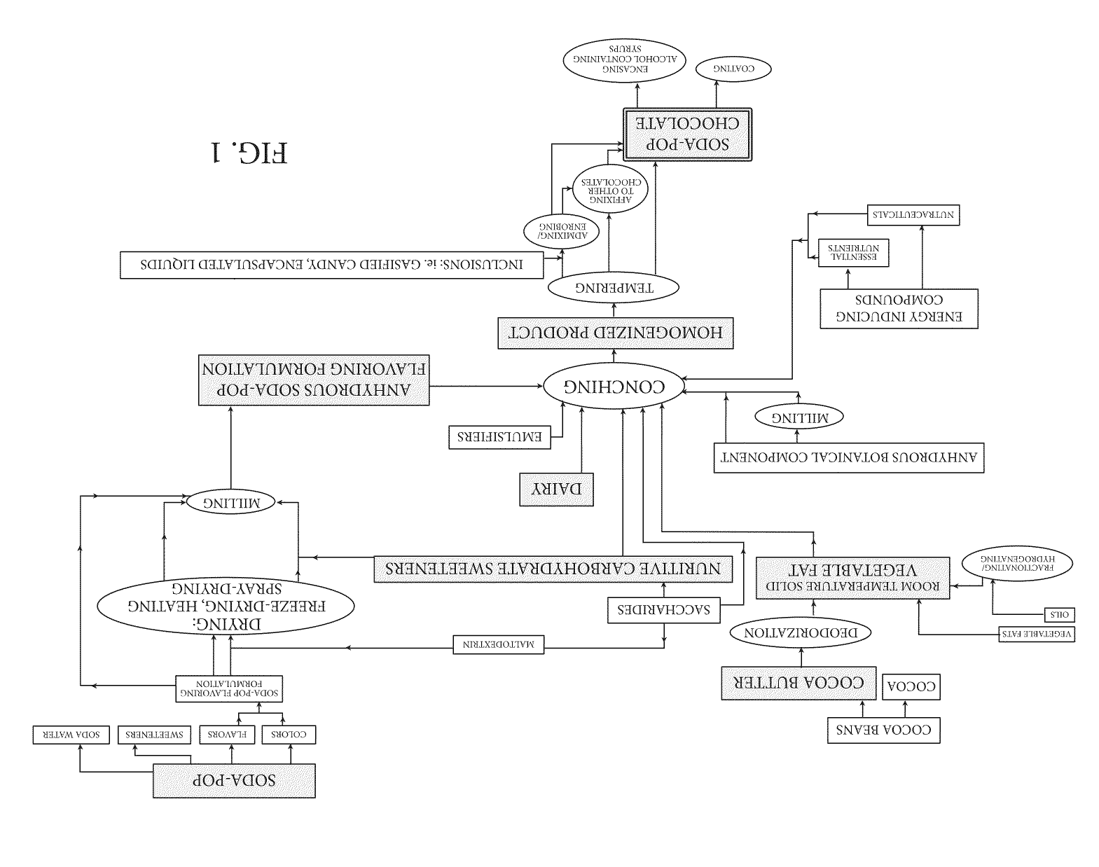

### DETAILED DESCRIPTION

All terms used herein are intended to have their ordinary meaning unless otherwise provided.

The present inventor has discovered that if a powdered anhydrous soda-pop flavoring formulation is intimately incorporated into the lipid constituent of a fat based confection, similar to white chocolate, then the flavor of the soda-pop will feature prominently in the confection. Featured prominently in the recipe are an anhydrous soda-pop flavoring formulation, a suitable confectionary fat, a dairy product, and a sweetener. The combination of and the process by which such ingredients are prepared and combined are that which makes this product unique.

Confection

In a primary embodiment of the inventive fat based confection, the confection has an anhydrous soda-pop flavoring formulation, a dairy product, a sweetener, and a suitable confectionary fat.

The flavoring of a confection of the current invention is derived from the soda-pop flavoring formulation. Soda-Pop refers generally to non-alcoholic carbonated beverages also referred to alternatively as colas, pops, tonics, soft drinks, soda, gaseosas, refrigerantes, soda water, and/or fizzy drinks, and herein the term soda-pop is intended to encompass these and all alternative names for carbonated beverages. Further, flavoring formulations may refer to all formulations possessing the flavor of the soda-pop including, but not limited to, soda-pop as provided to the general public for consumption, i.e. available within cans, bottles, and pre-mixes for immediate consumption; concentrates of the soda-pop—ready to consume soda-pops in which the water content has been reduced by about 1-99.5%, typically greater than 90%; and concentrates of only the flavoring/coloring components of the soda-pop. For convenience the concentrates of only flavoring/coloring components of the soda-pop shall be referred to as a soda-pop flavoring formulation but shall encompass all of the previously mentioned terms as well. Preferably, the soda-pop flavoring formulation used within the current inventive confection is substantially free of fructose, and most preferably the soda-pop flavoring formulation is substantially free of sweeteners.

The soda-pop flavoring formulation may be of any proprietary soda-pop flavoring formulation available domestically or internationally, past or presently commercialized, including, but not limited to soda-pop flavoring formulations sold by the companies listed below under their various brand names. The companies and their brand names include, but are not limited to, the Coca-Cola Company, Atlanta, Ga.—brand names: Barq's™ Root Beer, Coca-Cola™, Fresca™, Fanta™, Mello Yello™, OK Soda™, Pibb Xtra™, Sour Power™, Tab™, Vault™, Smart, Inca Kola, Mezzo Mix, Maaza, Beverly, Frisco, Krest, BEAT, Joya, Manzana Lift, Senzao, Coca-Cola Julebrus, Quwat Jabal, Jaz Cola, Pop Cola, Sarsi, Mare Rosso, Portello, Quatro, and Relentless; Dr. Pepper/Seven Up, Inc., Plano, Tex.—brand names: Dr. Pepper™, 7-UP™, Canada Dry™, A&W™ Root Beer, A&W™ Root Beer, A&W™ Cream Soda, Cactus Cooler™, Crush™, Diet Rite™, dnL™, Hires™ Root Beer, Nehi™, R.C. Cola™, Stewart's Fountain Classics™, Schweppes™ Ginger ale, Squirt™, Sun Drop™, Sunkist™, Orangina™, and Vernors™ Ginger Ale; PepsiCo, Inc., Purchase, N.Y.—brand names: Pepsi™, Amp Energy™, Mountain Dew™, Mug™ Root Beer, Sierra Mist™, Slice™, Teem™, Dr. Brown's™, Josta™, Junkanoo, Schwip Schwap, Manzanita Sol, Concordia, Triple Kola, Sting, and Mirinda; Red Bull GmbH, Fuschl am See, Austria—Brand names: Red Bull™ and Red Bull™ Cola; Ale-8-One Bottling Company, Inc., Winchester, Ky.—brand name: Ale-8-One™; Select Beverage Company, Inc., Bolingbrook,—brand name: A.J. Canfields™; Hobarama, LLC/BAWLS Guaran, Miami, Fla.—brand name: BAWLS Gurana™; The Kroger Co., Cincinnati, Ohio—brand name: Big K™; Big Red, Inc., Austin, Tex.—brand name: Big Red™, Big Honey Lemonade, Big Pineapple, Big Peach, Big Blue, Big Red Float, and Retro Big Red; Blenheim Bottlers, Hamer, S.C.—brand name: Blenheim Ginger Ale Red Cap, Gold Cap, and White Cap; Boylan Bottling Company, Moonachie, N.J.—brand name: Boylans Birch Beers, Boylans Bottleworks, Boylan Seltzers, and Boylans The Natural Kind; The Monarch Beverage Company, Atlanta, Ga.—brand name: ACUTEfruit™, Ntrinsic™, Rush! Energy™, and CoMotion™; The Dad's Root Beer Co., LLC, Jasper, Ind.—brand name: Dad's™ Root Beer, Dr. Wells™, Sun Crest™, and Bubble UP™; Buffalo Rock Company, Birmingham, Ala.—brand name: Buffalo Rock™ Ginger Ale, Dr. Wham™, Grapico™, and Sunfresh™; Rockstar, Inc., Las Vegas, Nev.—brand name: Rockstar™; C&C Beverages, Inc., Cranford, N.J.—brand name: C&C Cola; Innovative Beverage Group Holdings, Inc., Houston, Tex.—brand name: drank®; Jones Soda, Co.®, Seattle Wash.—brand name: Jones Soda, Jones Pure Cane Soda™, and Whoopass Energy Drink™; The Double Cola Company, Chattanooga, Tenn.—brand name: Double Cola™, Ski™, Jumbo™, and Double Dry Ginger Ale; Tri-City Beverage, Johnson City, Tenn.—brand name: Dr. Enuf™; Frostop Beverages, Inc., Columbus, Ohio—brand name: Frostop™ Root beer; Gray's Brewing Co., Janesville, Wis.—brand name: Gray's™ Soda and Baumeister™; Cornucopia Beverages Inc., Bedford, N.H., which is owned by Coca-Cola,—brand name: Moxie™; Route 66 Sodas, Lebanon, Mo.—brand name: Route 66™; National Beverage Corp., Ft. Lauderdale, Fla.—brand name: Faygo™, Shasta™, Rip It™, Ritz™, Cascadia™, Ohana™, Big Shot™, and St. Nick's; Wet Planet Beverages, Pittsford, N.Y.—brand name: Jolt Cola in flavors such as Cherry Bomb, Citrus Climax, Orange Blast, White Lightening, Red Eye, and Electric Blue; Napa Valley Soda; Thornwood Estates; Autumn frost; and DNA (drink); Goya Foods, Inc., Secaucus, N.J.—brand name: Refresco Goya™; White Rock Products Corporation, Whitestone, N.Y.—brand name: White Rock®, Olde Brooklyn®, and Sioux City®; The Cott Corporation, Toronto, Canada—brand name: Sam's Choice™, Ben Shaws, Stars & Stripes, Vintage, Whistle, Vess-Up, Vess, Orient Emporium, GL-7, Red Rain Energy, and Aftershock Energy; International Flavors, Inc., Indianapolis, Ind.—brand name: Red Rock™; Crystal Beverage Corp., Kearny, N.J.—brand name: Guarna Brazilia™ and Vigor™; Manhattan Special, Brooklyn, N.Y.—brand name: Espresso Coffee Soda; Stevens Point Brewery, Stevens Point, Wis.—brand name: Point Premium™; Clover Club Bottling Corp., Chicago, Ill.—brand name: Green River, Dog N' Suds, Nesbitt's, Sioux City, and Barritt's Ginger Beer; Polar Beverages, Worcester, Mass.—brand name: Polar™, Unwind™, Goslings™, and IZZE™; Wegmans Food Markets, Inc.—brand name: WPOP™; Safeway, Inc:, Pleasanton, Calif.—brand name: Safeway Select™ Soda's; Sprecher Brewery, Milwaukee, Wis.—brand name: Sprecher™; Imbibe Company, Chicago Ill.—brand name: Sopranos™; Blitz-Weinhard Co., Portland, Oreg.—brand name: Henry Weinhard's Sodas; and Nestle S.A., Vevey, Switzerland—brand name: S. Pelligrino™ Aranciata, Limonata, Sanbitter, and Chino; Hansen Natural, Corona, Calif.—brand name: Monster Energy, and Monster Nitrous; and other known bottling companies and their brand named sodas. The soda-pop flavor formulations may further include flavor and caloric variations of the above-named brand name soda pops, i.e. Vanilla Coke, Cherry Coke, Coke Zero, etc. Further, the soda-pop flavor formulations may include generic versions of the above-mentioned trade brands the formulation of which may be known to one of ordinary skill in the art as disclosed in Alan J. Mitchell, Formulation and production of carbonated soft drinks, Springer, 1990, hereby incorporated by reference in its entirety.

The soda-pop flavoring formulation is preferably dehydrated, and more preferably rendered substantially anhydrous (about 97.5% or more free of water, preferably about 98% or more free of water, more preferably 99% free of water, and most preferably more than 99.5% free of water), and most preferably rendered completely anhydrous, (100% free of water). Dehydration of the soda-pop flavorings may be accomplished through various means known in the art including, but not limited to, freeze-drying, heating, spray drying, or combination thereof. Preferably, the soda-pop flavoring formulations are rendered anhydrous through the use of freeze drying.

It should first be noted that the freeze-dried components are those in which the water content has been sublimated. The freezing step is one in which the component to be dried is taken to a temperature and pressure lower than the triple point at which the solid and liquid phases of the water contained therein can exist. By increasing the temperature above 0° C., while keeping the pressure below 0.06 atmospheres (ATM), the water inside the material sublimates directly from a solid to a gas, bypassing the liquid phase, and thus drying the material leaving behind the water soluble flavor constituents.

The freeze-drying is carried out under vacuum. A primary drying phase may remove as much as 98% of water by sublimation; an additional drying phase is utilized to sublimate the remaining approximately 2% of water. Typically, once the component has been freeze-dried, the vacuum is broken with an inert gas such as nitrogen, and the freeze-dried product is further treated for purposes of the present invention.

Subsequent to the dehydration process the resulting product is mechanically processed, i.e., milled, crushed, pulverized, etc., to reduce the dehydrated soda-pop flavoring formulation to a powder. Preferably, the size of the particles within the powder are less than or equal to about 50 μm, preferable less than or equal to about 40 μm, more preferably less than or equal to about 30 μm, and most preferably less than or equal to about 15 μm. Alternatively, the particles of the powder have a D⁵⁰, the diameter below which 50% of the volume of all particles of a powder is found, is less than or equal to about 50 μm, preferable less than or equal to about 40 μm, more preferably less than or equal to about 30 μm, and most preferably less than or equal to about 15 μm. More preferably the particles within the powder exhibit a D⁹⁰, the diameter below which 90% of the volume of all particles of a powder is found, of less than or equal to about 50 μm, preferable less than or equal to about 40 μm, more preferably less than or equal to about 30 μm and most preferably less than or equal to about 15 μm.

Further, the freeze-dried or otherwise dehydrated soda-pop flavoring formulation may be milled in the presence of a saccharide including, but not limited to, sucrose, maltodextrin, etc. The saccharide may act as a desiccant, preventing the rehydration of the soda-pop flavoring formulation, as well as a milling aid.

The percentage of the product comprised of the powdered anhydrous soda-pop flavoring formulation is dependent on each formulation's individual flavor intensity, but should not exceed about 35% by weight of the resulting confection, preferably not more than 30% by weight of the resulting confection, and most preferably not more than about 25% by weight of the resulting confection.

The confections of the current invention include sweeteners—carbohydrate, nutritive, non-nutritive, crystalline and/or amorphous (examples of suitable amorphous sweeteners are provided within PCT/US2006/021130 entitled “Chocolate Products Containing Amorphous Solids And Methods of Producing Same” published as WO 2006/130698, and hereby incorporated by reference in its entirety) sweeteners. Preferably, the confection includes nutritive sweeteners including, but not limited to, sucrose, and more preferably includes crystalline nutritive sweeteners. Preferably no greater than about 55% by weight of the above-noted sweeteners are used with the confections of the current invention. When a soda-pop flavor formulation incorporating a sweetener is used within the current invention, it may act as a substitute for a portion of or the entirety of the sweetener within the confection of the current invention. In such instances the amount of the soda-pop flavor formulation may exceed about 35% by weight of the resulting confection given that it is also providing the sweetener for the confection, but the amount of the soda-pop flavor formulation should not exceed about 55% by weight of the resulting confection.

The confections of the current invention also incorporate the dairy products, including, but not limited to, cream, milkfat, butter, milk, concentrated milk, evaporated milk, sweetened condensed milk, dried milk, skim milk, concentrated skim milk, evaporated skim milk, sweetened condensed skim milk, nonfat dry milk, sweet cream buttermilk, concentrated buttermilk, dried buttermilk, malted milk, cultured milk (yogurt, Kefir, etc.), dried cultured milk, whey, whey products, or combinations thereof. The dairy product solids may be present in an amount equal to or greater than about 5% by weight of the resulting confection, preferably it is greater than or equal to about 10% by weight of the resulting confection, and most preferably greater than or equal to about 14% by weight of the resulting confection. Additionally, it is preferred that milk fats comprise equal to or greater than 3.5% by weight of the resulting confection.

Preferably, the sweeteners and dairy products are rendered anhydrous, preferably completely anhydrous, and reduced to a powder using known methods. Preferably, the size of the particles within the powder are less than or equal to about 50 μm, preferable less than or equal to about 40 μm, more preferably less than or equal to about 30 μm, and most preferably less than or equal to about 15 μm. Alternatively, the particles of the powder have a D⁵⁰ less than or equal to about 50 μm, preferable less than or equal to about 40 μm, more preferably less than or equal to about 30 μm, and most preferably less than or equal to about 15 μm. More preferably the particles within the powder exhibit a D⁹⁰ of less than or equal to about 50 μm, preferable less than or equal to about 40 μm, more preferably less than or equal to about 30 μm, and most preferably less than or equal to about 15 μm.

The soda-pop confection of the current invention includes suitable confectionary fats, i.e. fats, oils, stearins, or combination thereof that have a melting point/range of around 34-38° C. (93-100° F.), that render the chocolate or chocolate-like confection solid at room temperature yet readily meltable within a person's mouth. Such suitable confectionary fats include, but are not limited to, cocoa butter, natural or synthetic cocoa butter alternatives, and/or combinations thereof. Cocoa butter alternatives include, but are not limited to, cocoa butter substitutes, cocoa butter replacers, or cocoa butter equivalents. Cocoa butter substitutes have similar physical properties, but not chemical composition, to cocoa butter. Cocoa butter substitutes tend to be lauric fats or oils which include, but are not limited to, fats derived from palm kernel oil and/or coconut oil. Additional cocoa butter substitutes are disclosed within U.S. Pat. Nos. 5,387,429; 4,157,405; 4,348,423; 4,601,790; 5,188,858; 3,537,865, 3,012,891, 3,012,890; 2,975,062; 4,822,875; 3,856,831; 5,275,835; 2,975,061; 2,993,063; 3,093,480; 6,210,739; 5,932,275; 4,072,766; and 4,839,192; hereby incorporated by reference in their entirety. Cocoa butter replacers include non-lauric high trans-fats that include, but are not limited to, fractionated or partially hydrogenated soybean oil, rapeseed oil, sunflower oil, palm oil, cotton seed oil, or other similar fats or oils. Additional cocoa butter replacers are disclosed within U.S. Pat. Nos. 5,405,639 and 6,229,033, hereby incorporated by reference in their entirety. Cocoa butter equivalents have similar physical properties as well as chemical composition to cocoa butter and can be used interchangeably with cocoa butter. These products are typically made by formulating high POP palm mid fraction with other exotic fats such as illipe fat, shea fat, mowra butter; kokum butter; borneo tallow, sal fat, mango fat, and/or other similar fats or oils. Cocoa butter equivalents are also disclosed within U.S. Pat. Nos. 5,210,241 and 5,171,604, hereby incorporated by reference in their entirety. Additionally, vegetable derived fats, oils or stearins may be suitable for use as confectionary fats of the current invention include, but are not limited to, oils and fats such as partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, shea butter; mowra butter; kokum butter; illipe butter; borneo tallow, or combinations thereof. Preferably, the confection of the current invention is manufactured using cocoa butter as the suitable confectionary fat, and most preferably, cocoa butter is the sole confectionary fat used within the confection.

In order to further the objective of this invention—a confection in which the predominant flavor impression is that of a soda-pop—the suitable confectionary fat, cocoa butter, or cocoa butter alternatives may be deodorized to reduce their inherent olfactory or flavoring qualities and further enhance the flavoring of the soda-pop flavoring within the resulting confection. This may be done using known deodorizing processes within the art including those disclosed within U.S. Pat. No. 4,601,790, hereby incorporated by reference in its entirety.

The suitable confectionary fat is present within the current confection from about 7% to about 50% by weight of the overall confection, preferably about 10% to about 45% by weight of the confection; and more preferably about 20% to about 35% by weight of the confection. Alternatively, the suitable confectionary fat is present in amount of about 20% or greater by weight of the overall confection. Most preferably, cocoa butter is used within the amounts and ranges disclosed within 21 C.F.R.—Food and Drugs, Chapter 1—Food and Drug Administration, Department of Health and Human Services, Part 163—Cacao Products, The Cocoa and Chocolate Products (England) Regulations, 2003 No. 1659, IBN0110466705 and 2009 revision thereof; and/or Directive 2000/36/EC relating to cocoa and chocolate products intended for human consumption, OJ 2000 L 197, hereby incorporated by reference in their entirety.

Emulsifiers may also be added as necessary for optimum mouth feel and palatability. Suitable emulsifiers include, but are not limited to, lecithins such as those derived from soya, rape or sunflower seeds, fractionated lecithins, polyglycerol polyricinoleate, ammonium phosphatide (emulsifier YN), citric acid esters such as PALSGAARD Citrem 4201 (Palsgaard A/S, Julesmind, Germany), polyglycol olyricinoleate, sorbitan tristearate, sucrose esters, and/or combinations thereof. The total amount of emulsifiers is less than or equal to about 2% by weight of the resulting confection, preferably is less than or equal to 1.75% by weight of the resulting confection, and most preferably less than or equal to about 1.5% by weight of the resulting confection.

Compounds, which are active in nutritional physiology (nutraceuticals), preferably those known to increase energy, may also be added to the confection of the current invention. Additionally, a preferred embodiment would further include any nutraceuticals—essential nutrients (including vitamins [specifically B-vitamins], minerals, biogenic amines [including tuarine, l-carnitine], etc.), and/or natural/naturally-derived compounds (including but not limited to stimulants such as caffeine, guarana extractives, theobromine, theophylline, quercetin, ginseng extractives, methylxanthine, etc.) which are active in nutritional physiology and would be specifically included in amounts sufficient to provide for energy inducement and enhancement qualities.

Further, any safe and suitable flavoring agents (natural, organic, artificial, nature-identical, etc.) may be added including but not limited to anhydrous powdered botanical constituents, lipid soluble botanical extractives and/or saccharides may be added. Further, known colorants safe and suitable for use within the confection industry may be used as well to impart color to the confection of the current invention, which in certain embodiments may approximate the color of the soda-pop that imparts the flavor to the confection.

Culinary botanical components may be intimately incorporated into the product as either a health benefit or flavoring agent. Such botanical components may include but are not limited to extractives of vanilla; spice, herbal and root extractives; ground spices; ground herbs; ground nuts; ground coffee; essential oils; cold-pressed citrus oils; powdered anhydrous fruit based components such as those disclosed within U.S. patent application Ser. No. 12/930,796; powdered stevia extract; green tea powder; black tea powder; malted cereal extracts; combinations thereof and similar health and flavoring agents. Intimately incorporated components consistent with the soda-pop flavor may be intimately incorporated into the confection to ensure the predominance of the soda-pop flavor through an additive, cumulative or synergistic effect. Moreover, these elements, if present, are preferably present in amounts that do not detract from the soda pop flavor of the confection, i.e. the components do not interfere with the predominant or primary flavor impression of the soda-pop flavoring formulation.

Further saccharides including crystallized honey, turbinado sugar, dried agave cactus syrup, maple syrup crystals, dried brown rice syrup, caramelized sugar, soluble dietary fibers, inulins, fructo-oliogsaccharides (FOS), polydextrose, galacto-oligosaccharides (GOS), lactose, tagatose, maltodextrin or combinations thereof may be added.

Additionally, cocoa products other than cocoa butter, such as raw cocoa powder, dutched cocoa powder, and/or chocolate liquor, may be added to the confections of the current invention. However, the additional cocoa products should be present in forms and amounts that do detract from the current confections predominant or primary soda-pop flavor impression.

The particle size of the included solids components is generally less than 15 μm; with an ideal size <2 μm. Alternatively, the particles of the solid components may have a D⁵⁰ less than or equal to about 15 μm, preferable less than or equal to about 10 μm, more preferably less than or equal to about 5 μm, and most preferably less than or equal to about 2 μm. More preferably, the particles within the powder exhibit a D⁹⁰ of less than or equal to about 15 μm, preferable less than or equal to about 10 μm, more preferably less than or equal to about 5 μm, and most preferably less than or equal to about 2 μm. The reduction of such particle sizes are a result of either milling or the conching process.

Gasified candy, encapsulated liquids, or any other inclusions, may be admixed at this time prior to the molding of, or the enrobing by, the current chocolate candy product through means known to those in the art of chocolate candy making. In still other preferred embodiments, inclusions such as nuts, ground nuts, dried fruit, freeze-dried fruit, candied fruit, candied ginger, cocoa nibs, wafers, cookies, pretzels, biscuits, crisped/puffed grains may be admixed to, or otherwise enveloped by, the product prior to letting the product set.

Another preferred embodiment would be the incorporation into the product of inclusions, such as candy—but more specifically gasified candy through a process by which the candy has been prepared in its molten state in the presence of pressurized gas, so that when cooled and allowed to harden the resulting candy will have included therein bubbles of pressurized gas as disclosed in U.S. Pat. No. 4,289,794, incorporated herein in its entirety by reference. The gas is then released when the walls of the hard candy encasing the pressurized gas is weakened. Further, the incorporation through admixture of gasified candy would change the texture and mouth feel, as well as the consumer experience, when the current product in such variations is consumed, by introducing a carbonation effect to complement the soda-pop flavored confection.

Encapsulated liquids, typically flavor enhanced lipophilic core materials inside a seamless gelatin or alginate shell, may also be admixed prior to the setting of the product from a plastic to a semi-plastic state. U.S. Pat. Application #20080317824, hereby incorporated by reference in its entirety, describes a method for making chocolate coated spherical liquid filled microcapsules with a gelatin/plasticizer or alginate/plasticizer seamless shell.

Preferred embodiments may incorporate the inclusion of encapsulated liquids; such encapsulations are prepared by drip method—a process by which a seamless gelatin or alginate shell surrounding a core liquid is obtained by simultaneously pumping through a concentric multi-component nozzle the core material, which is preferably lipophilic (and thus hydrophobic), and a gelatin/alginate aqueous solution (shell material) so that droplets drip into a lipophilic cooling liquid, thereby hardening the shell.

In another preferred embodiment the chocolate confection is molded into a shape that has an internal reservoir. The reservoir may contain various creams, jellies, whole fruits, nuts, nougats, syrups, or similar items typically encased within chocolate confections. In a particular embodiment, the chocolate confection may encase, or contain within the reservoir, a syrup with an alcohol content less than 10%. Such an embodiment is a means for providing a confection whose flavor profiles mimic those found in alcoholic beverages, i.e. Rum and Coke. After the filing has been loaded into the reservoir through an injection into the chocolate or an opening within the molded chocolate the reservoir is closed by means known in the art such as a chocolate cap or reheating the area of the confection so that the melted chocolate seals the opening or injection site.

Still another preferred embodiment would include the product coated in a candy shell, confectioners glaze or wax, to prevent the chocolate from melting in the hands of the consumer.

Other preferred embodiments would be the product as a component to another product, such as a baking chip or coating.

Other preferred embodiments would be the product as a component in a product that includes other forms of ‘chocolates’ as described in the U.S. Code of Federal Regulations, Title 21, Chapter 1, Part 163—COCOA PRODUCTS—Subpart B, such as layers of fruit chocolate affixed to a ‘milk chocolate’ layer or a ‘white chocolate’ layer by the interlacing matrix of cocoa butter crystals that form when these layers set from a plastic stage to a semi-plastic stage.

Manufacture

The fat base of the present invention is a suitable confectionary fat which emulates the principal fat constituent of ‘chocolate’. It follows that the manufacture of the product, in keeping with the present invention, will utilize conventional chocolate making processes and apparatus as disclosed within industry treatises such as: Industrial Chocolate Manufacture and Use, 3d Ed., S.T. Beckett, ed., 1999; Bernard W. Minifie, Chocolate, Cocoa, and Confectionery, 3d ed., Aspen Publishers, Inc., 1999; and Emmanuel Ohene Afoakwa, Chocolate Science and Technology, John Wiley and Sons, 2010. Particularly, the manufacturing process will emulate the manufacturing process of other various kinds of chocolate, by varying the amount of sugar and milk products, in conjunction with the powdered anhydrous soda-pop flavor formulations/components and other ingredients that may be employed in the manufacture of the current invention. The preparation of the present cocoa butter based invention follows essentially the same preparation steps as the preparation of conventional chocolate. That is to say the usual chocolate making steps, particularly after the separation of cocoa butter from the cocoa liquor, including the conching process are employed.

The intense conching process not only assures complete coating of every solid particle with the suitable confectionary fat such as cocoa butter, but also further reduces particle size, measured in terms of microns, of the various powdered ingredients to no more than about 15 μm, smaller than the tongue can detect, resulting in the state of the product being both homogenous and smooth. The longer the conching process continues the smoother the end product becomes. Preferably, the powdered ingredients are reduced to particles less than or equal to about 10 μm, more preferably less than or equal to about 5 μm, and most preferably less than or equal to about 2 μm. More preferably, the particles within the powdered ingredients are reduced to a D⁵⁰ of less than or equal to about 15 μm, preferable less than or equal to about 10 μm, more preferably less than or equal to about 5 μm, and most preferably less than or equal to about 2 μm. Most preferably, the particles of the powdered ingredients are reduced to a D⁹⁰ of less than or equal to about 15 μm, preferable less than or equal to about 10 μm, more preferably less than or equal to about 5 μm, and most preferably less than or equal to about 2 μm.

The final step, tempering, is employed. The crystallization of the cocoa butter is controlled by temperature in order to create conditions suitable for the most stable form, which occurs at about 34° C.

The chocolate is first heated to 45° C. (115° F.) to melt all six forms of crystals. It is then cooled to about 27° C. (80° F.), which allow only crystal types IV (also referred to as β∝ and V (also referred to as β) to form. At this temperature, the chocolate is agitated to create many small crystals which will serve as “seeds” to create small crystals in the chocolate. The chocolate is then heated to about 31° C. (88° F.) to eliminate any type IV crystals, leaving just type V.

In a preferred embodiment the confection is as a stand-alone product; a unique chocolate, as in a traditional candy bar or bon bon, highlighting individual and popular carbonated soft-drink flavors. It may additionally be used in manners consistent with chocolate candy making, which would be familiar to those skilled in the art.

All references including patent applications and publications cited herein are incorporated herein by reference in their entirety and for all purpose to the same extent as if each individual publication or patent or patent application was specifically and individually indicated to be incorporated by reference in its entirety for all purposes. Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A soda-pop confection comprised of:
A. a sweetener;
B. a dairy product;
C. an anhydrous soda-pop flavoring; and
D. a suitable confectionary fat.

2. The soda-pop confection of claim 1, wherein the anhydrous soda-pop flavoring comprises less than about 35% by weight of the confection.

3. The soda-pop confection of claim 2, wherein the particle size of the anhydrous soda-pop flavoring has a D⁹⁰ less or equal to about 15 μm.

4. The soda-pop confection of claim 1, wherein the dairy product is cream, milkfat, butter, milk, concentrated milk, evaporated milk, sweetened condensed milk, dried milk, skim milk, concentrated skim milk, evaporated skim milk, sweetened condensed skim milk, nonfat dry milk, sweet cream buttermilk, concentrated buttermilk, dried buttermilk, malted milk, cultured milk, dried cultured milk, or combinations thereof.

5. The soda-pop confection of claim 1, wherein the anhydrous soda-pop flavoring is further comprised of an anti-caking agent.

6. The soda-pop confection of claim 5, wherein the anti-caking agent is maltodextrin.

7. The soda-pop confection of claim 1, wherein the suitable confectionary fat is a vegetable derived fat, oil, stearin, or combination thereof.

8. The soda-pop confection of claim 7, wherein the vegetable derived fat is cocoa butter, shea butter; mowra butter; kokum butter; illipe butter; borneo tallow, or combinations thereof.

9. The soda-pop confection of claim 7, wherein the vegetable derived oil is partially hydrogenated palm kernel oil, partially hydrogenated coconut oil, partially hydrogenated palm oil; fractionated palm kernel oil, fractionated palm oil, fractionated coconut oil, fractionated corn oil, fractionated peanut oil, fractionated soy oil, fractionated cottonseed oil, fractionated sunflower oil, fractionated safflower oil, or combinations thereof.

10. The soda-pop confection of claim 8, wherein the vegetable derived fat is cocoa butter.

11. The soda-pop confection of claim 1, further comprising an emulsifying agent.

12. The soda-pop confection of claim 11, wherein the total amount of the emulsifying agent does not exceed about 2 percent by weight of the soda-pop confection.

13. The soda-pop confection of claim 1, wherein the soda-pop confection further comprises an essential nutrient, a mineral, a biogenic amine, an herbal extract, a stimulant, and or combinations thereof to provide an energy enhancement.

14. The soda-pop confection of claim 1, wherein the soda-pop confection incorporates one or more inclusions.

15. The soda-pop confection of claim 14, wherein the inclusion is gasified candy, encapsulated liquid, cookies, wafers, nougat, caramel, carob, pralines, crisped or puffed grains, taffy, toffee, pretzels, nuts, seeds, dried fruit, and combinations thereof.

16. The soda-pop confection of claim 14, wherein the encapsulated liquid is comprised of a flavor enhanced lipophilic core inside a gelatin or alginate shell.

17. The soda-pop confection of claim 1, wherein the soda-pop confection is coated with a candy shell, confectioners glaze, confectioners wax or combination thereof.

18. The soda-pop confection of claim 1, wherein the soda-pop confection is molded into the shape of a container or vessel having a closed reservoir therein and wherein said closed reservoir contains a syrup with an alcohol content of less than about 10%.

19. The soda-pop confection of claim 1, which further comprises raw cocoa powder, dutched cocoa powder, chocolate liquor.

20. The soda-pop confection of claim 1, wherein the sweetener is a nutritive sweetener.
